(19) United States
(12) Patent Application Publication
(10) Pub. No.: US 2008/0059904 A1
(43) Pub. Date: Mar. 6, 2008

(54) METHOD, APPARATUS, AND COMPUTER PROGRAM PRODUCT FOR IMPLEMENTING ENHANCED WINDOW FOCUS IN A GRAPHICAL DESKTOP

(76) Inventors: Christopher Patrick Abbey, Rochester, MN (US); Jeffrey Jay Scheel, Rochester, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/468,664

(22) Filed: Aug. 30, 2006

(51) Int. Cl. G06F 3/048

(52) U.S. Cl. 715/802; 715/767

(57) ABSTRACT

A method, apparatus and computer program product implements enhanced window focus in a graphical desktop. Checking whether a desktop is in focus is performed. Responsive to the desktop not being in focus, the desktop is explicitly distorted and then drawn. Responsive to identifying items to be updated, checking whether the items are in focus is performed. Responsive to the items not being in focus, the items are explicitly distorted and then drawn.

### FIELD OF THE INVENTION

The present invention relates generally to the data processing field, and more particularly, relates to a method, apparatus and computer program product for implementing enhanced window focus in a graphical desktop.

### DESCRIPTION OF THE RELATED ART

Graphical user interfaces (GUIs) provided for windowing desktops can become cluttered quickly if users are not meticulous in managing them. The addition of collaboration applications, such as instant messaging, electronic meetings, and even simple email, with their capacity for real-time information updates can increase the speed of this clutter.

While most users can generally handle the management of these interrupts, most users at some point in time find the interrupts annoying or even unmanageable. Conventional options for managing these interrupts are basic, such as do not use or start the application, or try to ignore it.

In this environment, many applications are escalating the tactics used to get the attention of the user; this can especially be seen in the tactics of web advertisers surrounding their content with dancing brightly colored imagery in an attempt to catch a users attention. Some users with medical conditions, such as diagnosed attention deficit disorders may find these tools render their desktop environment unusable.

Most GUI desktops provide the idea of focus for the windows; this technique generally applies to how the system's input devices are targeted to the various running applications, and the behavior of how the window is rendered such as the colors of the window decorations. For example, a window touched by the mouse might auto-raise to appear on top or as the frontmost window while becoming the focused window, or the color of the title bar might change from a color indicating it is not selected to a color indicating it is selected, for example, changing from a gray to a blue. Also the desktop may be configured to require a click of the mouse to provide this focus. A component typically gains the focus by the user clicking it, tabbing between components, or otherwise interacting with a component.

Various arrangements have been proposed for providing GUI desktops.

U.S. Pat. No. 6,157,733 to Swain, issued Dec. 5, 2000, discloses a method where one or more monocular cues are extracted from an original image and combined to enhance depth effect. An original image is acquired and segmented into one or more objects. The objects are identified as being either in the foreground or the background, and an object of interest is identified. One or more depth cues are then extracted from the original image, including shading, brightness, blur and occlusion. The depth cues may be in the form of one or more intermediate images having an improved depth effect. The depth cues are then combined or applied to create an image with enhanced depth effect.

U.S. Pat. No. 6,784,879 to Orr, issued Aug. 31, 2004, discloses a method and apparatus for controlling background video on a computer display that is accomplished by providing a video control icon, which is visible on the display. The video control icon relates to the live video being displayed as the background. Once selection of the video control icon has been detected, the computer displays a control panel for the live video while the live video remains in the background. As such, when a user desires to change an attribute of the live video, the user selects the video control icon, which pops up a control panel. The user then makes an adjustment via the control panel to the live video and once such an adjustment is made, the control panel is removed from the screen. All this done while the live video remains in the background, thus other applications that were in focus remain in focus.

U.S. patent publication US 2003/0169299 A1 to Kusano et al., published Sep. 11, 2003, discloses a GUI for enabling a user to navigate between a wide variety of options. With the trend of offering more applications and options to the user, like in a set top box (STB) deployed in a living room, it becomes desirable to present the options in an intuitive and user-friendly manner. Only user options are selectable, on a TV screen, which are currently of direct interest to the user. The user can navigate between these options using a relative simple input device like a remote control. Other options are shown semi visible in the background and appear in a dormant state. With a separate button on the input device these options can be made completely visible and can even be emphasized using an animation on the screen. The GUI is especially well suited for in a data driven application environments.

A need exists for an effective mechanism for implementing enhanced window focus in a graphical desktop.

### SUMMARY OF THE INVENTION

Principal aspects of the present invention are to provide a method, apparatus and computer program product for implementing enhanced window focus in a graphical desktop. Other important aspects of the present invention are to provide such method, apparatus and computer program product for implementing enhanced window focus in a graphical desktop substantially without negative effect and that overcome many of the disadvantages of prior art arrangements.

In brief, a method, apparatus and computer program product implements enhanced window focus in a graphical desktop. Checking whether a desktop is in focus is performed. Responsive to the desktop not being in focus, the desktop is explicitly distorted and then drawn. Responsive to identifying items to be updated, checking whether the items are in focus is performed. Responsive to the items not being in focus, the items are explicitly distorted and then drawn.

In accordance with features of the invention, desktop and items identified as being in focus are drawn as normal, without any distorting action. The desktop and the items not being in focus are explicitly distorted by a selected one of or a selected combination of desaturating colors of the desktop and items not being in focus, and blurring the desktop and items not being in focus. Blurring the desktop and items not being in focus are selectively provided by applying a predefined Gaussian blur or a heavy blurring function to the desktop and the items not being in focus.

In accordance with features of the invention, at least one background control rule is stored to define an explicit action for distorting the desktop and items not being in focus.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A and 1B are block diagram representations illustrating an exemplary computer system and operating system for implementing enhanced window focus in a graphical desktop in accordance with the preferred embodiment;

FIGS. 2, 3, 4, and 5 are flow charts illustrating exemplary steps for implementing enhanced window focus in a graphical desktop in accordance with the preferred embodiment;

FIGS. 6, 7, 8, and 9 illustrate exemplary graphical desktop displays implementing enhanced window focus in a graphical desktop in accordance with the preferred embodiment; and

FIG. 10 is a block diagram illustrating a computer program product in accordance with the preferred embodiment.

### DETAILED DESCRIPTION OF THE PREFERRED EMBODIMENTS

In accordance with features of the preferred embodiments, explicit action are taken on windows in the background to unfocus or distort them, increasing the focus on an intended window but removing all indications of the state of the background window. Suitable methods for accomplishing this include adjusting color saturation and/or applying a diffusion or blur.

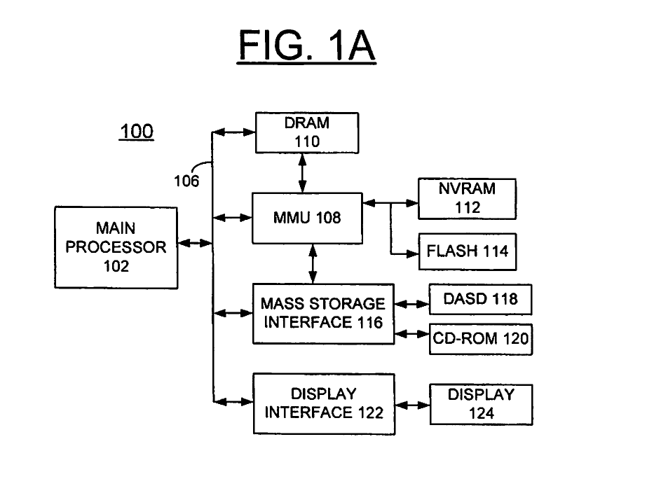

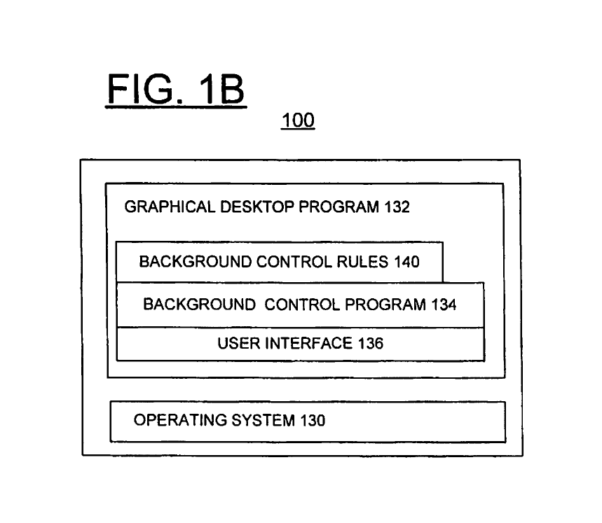

Having reference now to the drawings, in FIGS. 1A and 1B, there is shown an exemplary server or computer system generally designated by the reference character 100 for implementing methods for providing enhanced window focus in a graphical desktop in accordance with the preferred embodiment. Computer system 100 includes a main processor 102 or central processor unit (CPU) 102 coupled by a system bus 106 to a memory management unit (MMU) 108 and system memory including a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102. Computer system 100 includes a display interface 122 coupled to the system bus 106 and connected to a display 124.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, multiple main processors.

As shown in FIG. 1B, computer system 100 includes an operating system 130, a graphical desktop program 132, a background control program 134 of the preferred embodiment, and a user interface 136. Background control rules 140 are identified and stored in accordance with user selections for selectively implementing enhanced window focus in a graphical desktop in accordance with the preferred embodiment.

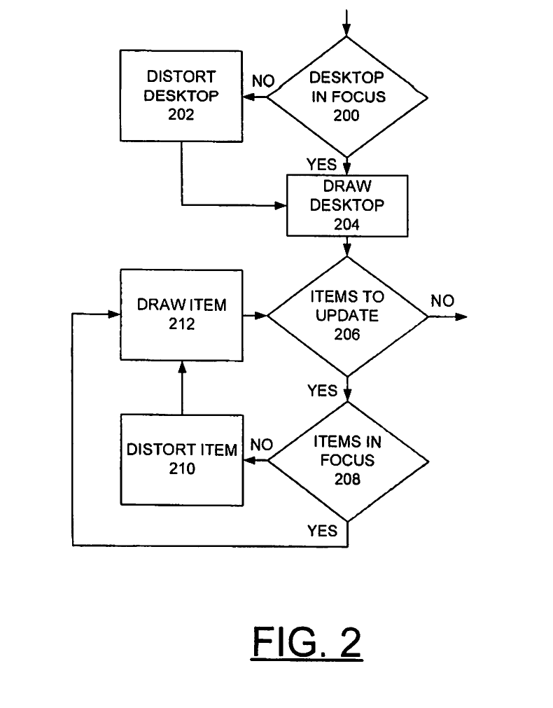

Various commercially available computers can be used for computer system 100, for example, an IBM personal computer or an IBM server computer, such as an IBM System p™ server computer. CPU 102 is suitably programmed by the graphical desktop program 132 and the background control program 134 to execute the flowcharts of FIGS. 2, 3, 4, 5, and 6 for implementing methods for providing enhanced window focus in a graphical desktop in accordance with the preferred embodiment.

In accordance with features of the preferred embodiments, a method provides a user an effective mechanism for unfocusing or distorting background windows. The invention explicitly distorts the background on a windows graphical display system with the intent of reducing the visual impact on changes to windows not presently in focus.

Referring to FIGS. 2, 3, 4, and 5, there are shown flow charts illustrating exemplary steps for implementing enhanced window focus in a graphical desktop in accordance with the preferred embodiment.

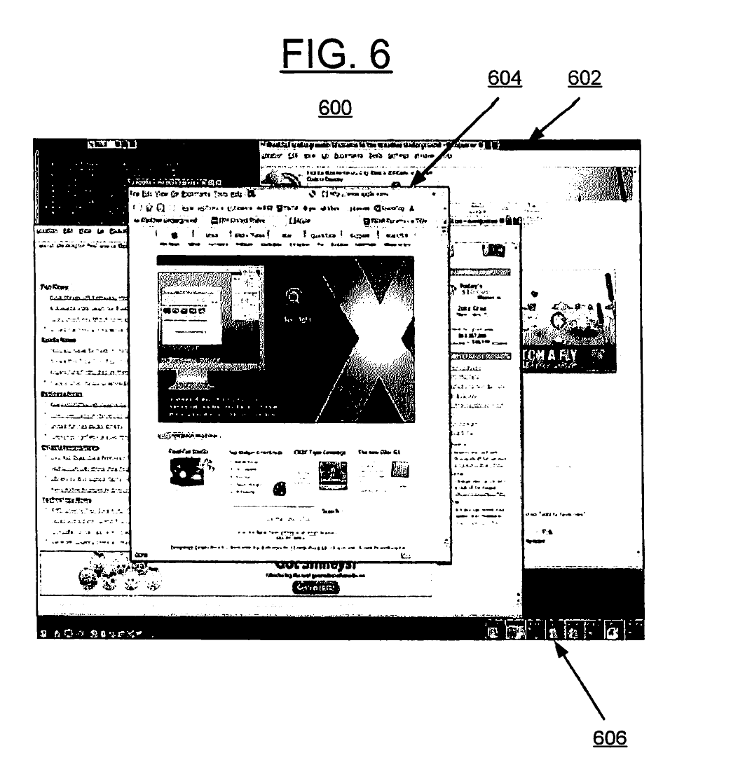

Referring also to FIGS. 6, 7, 8, and 9, there are shown exemplary graphical desktop displays implementing enhanced window focus in a graphical desktop in accordance with the preferred embodiment.

Referring to FIG. 2, there are shown exemplary steps for implementing enhanced window focus in a graphical desktop in accordance with the preferred embodiment. Enhanced window focus in a graphical desktop is provided in accordance with the preferred embodiment by selectively distorting the desktop and background windows. The desktop is a main screen in the graphical desktop where windows and icons acting as shortcuts to various programs are placed.

Exemplary operations start as indicated in a decision block 200 with checking whether the desktop is in focus. If the desktop is not in focus, then the desktop is explicitly distorted as indicated in a block 202. Next the desktop is drawn as indicated in a block 204. Checking for items to update is performed as indicated in a decision block 206. If items to be updated are identified at decision block 206, then checking whether the items to be updated are in focus as indicated in a decision block 208. If the items to be updated are not in focus, the items are explicitly distorted as indicated in a block 210. Next the items are drawn as indicated in a block 212.

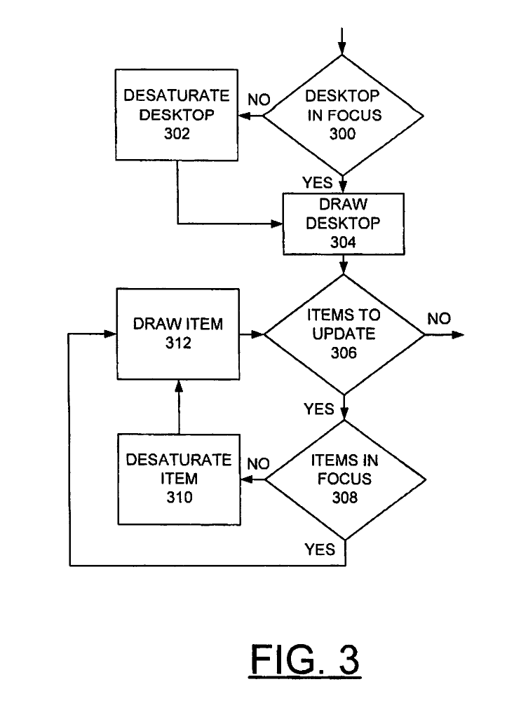

Referring to FIG. 3, there are shown exemplary steps for implementing enhanced window focus in a graphical desktop in accordance with the preferred embodiment. The first possible technique of adjusting focus is to adjust color assignments for background windows. For example, when the windows not in focus had their colors desaturated, the net effect of “graying” the background applications is achieved, thus increasing focus on the main window.

As shown in FIG. 3, enhanced window focus in a graphical desktop is provided in accordance with the preferred embodiment by selectively desaturating the desktop and background windows to selectively unfocus the desktop and background windows. Selectively desaturating the desktop and background windows includes adjusting a color saturation to provide enhanced window focus in a graphical desktop, and includes, for example, selectively dimming, inverting, or bleaching the desktop and the items not being in focus.

Referring also to FIG. 6, there is shown an exemplary graphical desktop display generally designated by the reference character 600 implementing enhanced window focus in accordance with one preferred embodiment. Graphical desktop display 600 includes a background portion including desktop and background windows generally designated by the reference character 602 having colors desaturated, the net effect of graying the background applications, thus increasing focus on a main window generally designated by the reference character 604. Optionally, as shown, the desktop control toolbars generally designated by the reference character 606 at a lower corner of the screen also remain in focus.

Exemplary operations start as indicated in a decision block 300 with checking whether the desktop is in focus. If the desktop is not in focus, then the desktop is desaturated to explicitly unfocus the desktop as indicated in a block 302. Next the desktop is drawn as indicated in a block 304. Checking for items to update is performed as indicated in a decision block 306. If items to be updated are identified at decision block 306, then checking whether the items to be updated are in focus as indicated in a decision block 308. If the items to be updated are not in focus, the items are desaturated to explicitly unfocus the items as indicated in a block 310. Next the items are drawn as indicated in a block 312.

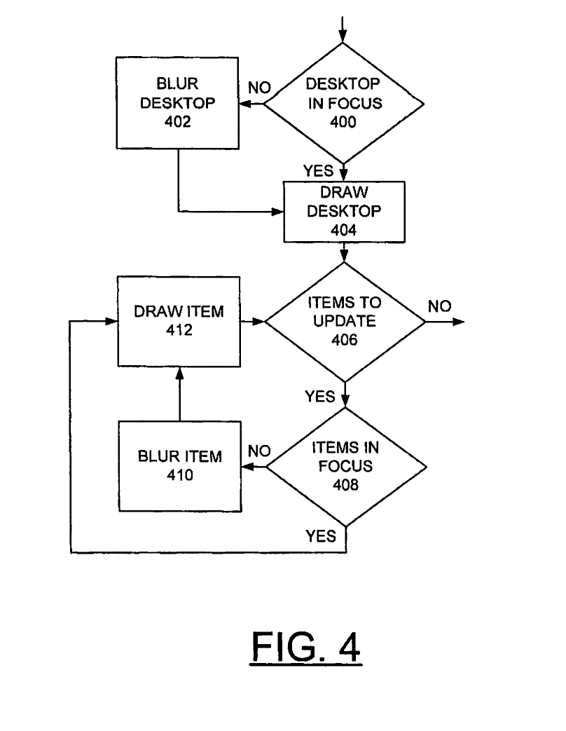

Referring to FIG. 4, there are shown exemplary steps for implementing enhanced window focus in a graphical desktop in accordance with the preferred embodiment. Selectively providing a variable degree of blurring to the desktop and background windows provides enhanced window focus in a graphical desktop. For example, using a simple Gaussian blur can explicitly unfocus the background, thus increasing focus on a main window.

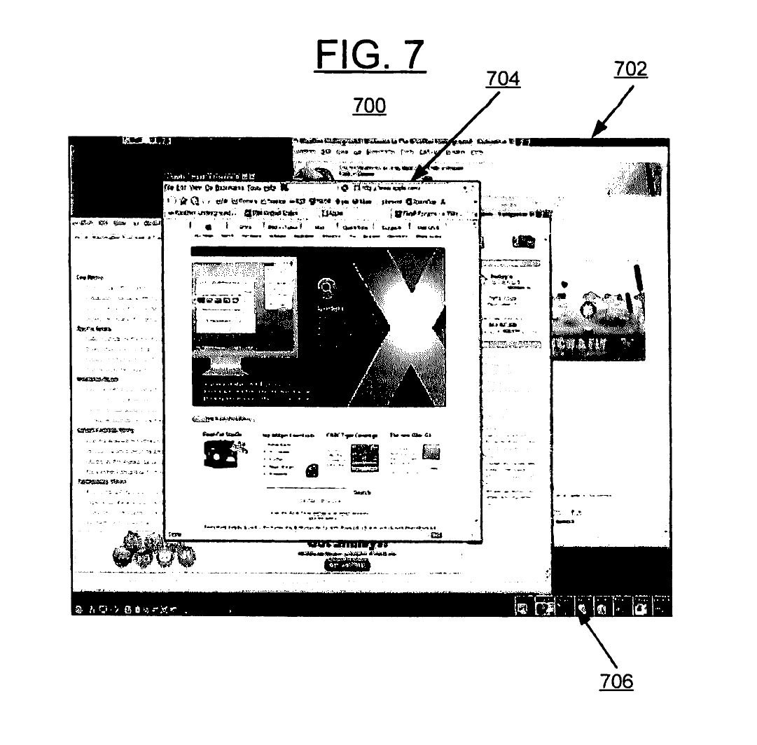

Referring also to FIG. 7, there is shown an exemplary graphical desktop display generally designated by the reference character 700 implementing enhanced window focus in accordance with one preferred embodiment. Graphical desktop display 700 includes a background portion including desktop and background windows generally designated by the reference character 702 having selected degree of blurring applied, for example, using a simple Gaussian blur thus increasing focus on a main window generally designated by the reference character 704. Optionally, as shown, the desktop control toolbars generally designated by the reference character 706 at a lower corner of the screen also remain in focus.

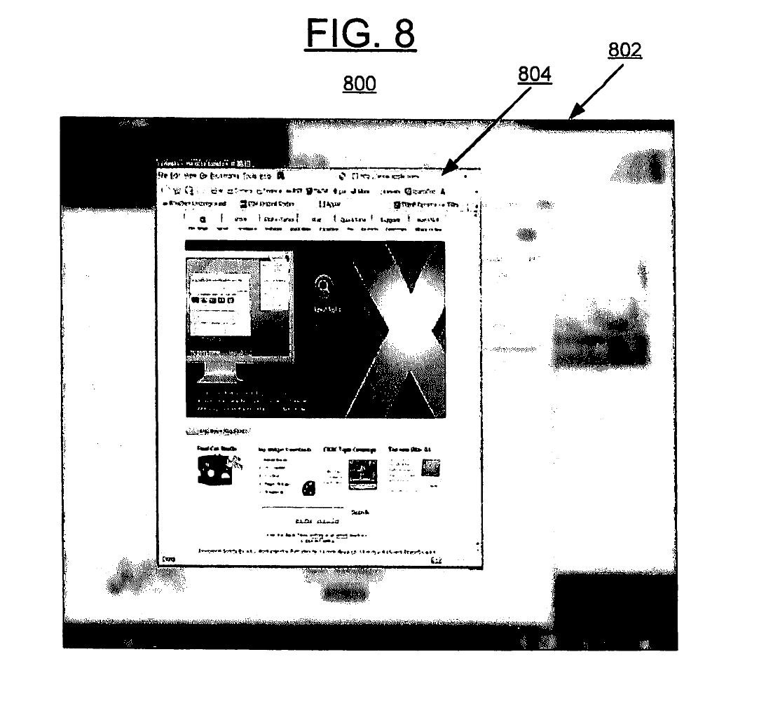

Referring also to FIG. 8, there is shown an exemplary graphical desktop display generally designated by the reference character 800 implementing enhanced window focus in accordance with one preferred embodiment. Graphical desktop display 800 includes a background portion including desktop and background windows generally designated by the reference character 802 having selected degree of blurring applied, for example, using a heavier blur thus increasing focus on a main window generally designated by the reference character 804. Optionally, as shown, the desktop control toolbars at a lower corner of the screen also have the selected degree of blurring applied and are explicitly distorted with the background 802.

Exemplary operations start as indicated in a decision block 400 with checking whether the desktop is in focus. If the desktop is not in focus, then the desktop is blurred to explicitly unfocus the desktop as indicated in a block 402. Next the desktop is drawn as indicated in a block 404. Checking for items to update is performed as indicated in a decision block 406. If items to be updated are identified at decision block 406, then checking whether the items to be updated are in focus as indicated in a decision block 408. If the items to be updated are not in focus, the items are blurred to explicitly unfocus the items as indicated in a block 410. Next the items are drawn as indicated in a block 412.

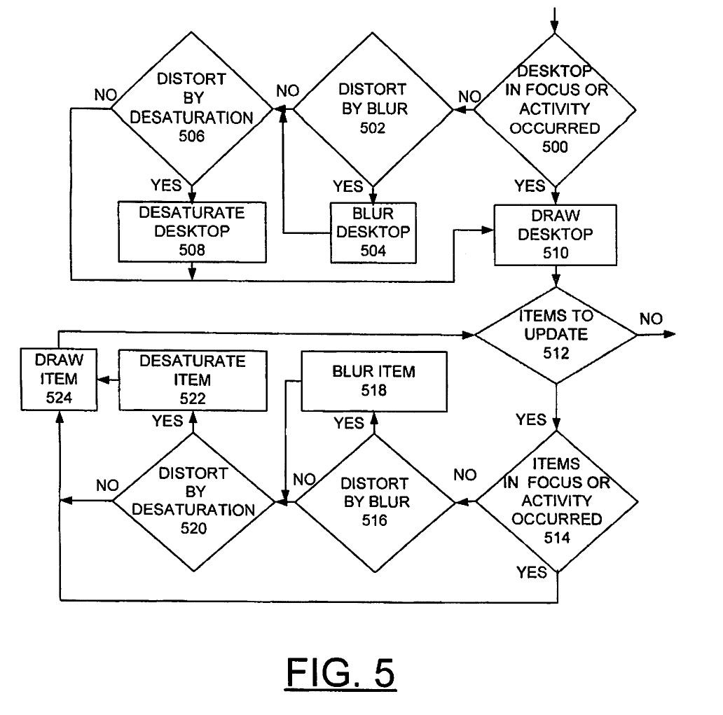

Referring to FIG. 5, there are shown exemplary steps for implementing enhanced window focus in a graphical desktop in accordance with the preferred embodiment. Selectively providing a selected combination of distorting techniques, such as selectively providing a combination of selectively desaturating colors and selectively providing a variable degree of blurring to the desktop and background windows provides enhanced window focus in a graphical desktop. Also setting a default behavior of background windows on a graphical desktop advantageously is implemented with the enhanced window focus in a graphical desktop in accordance with the preferred embodiment.

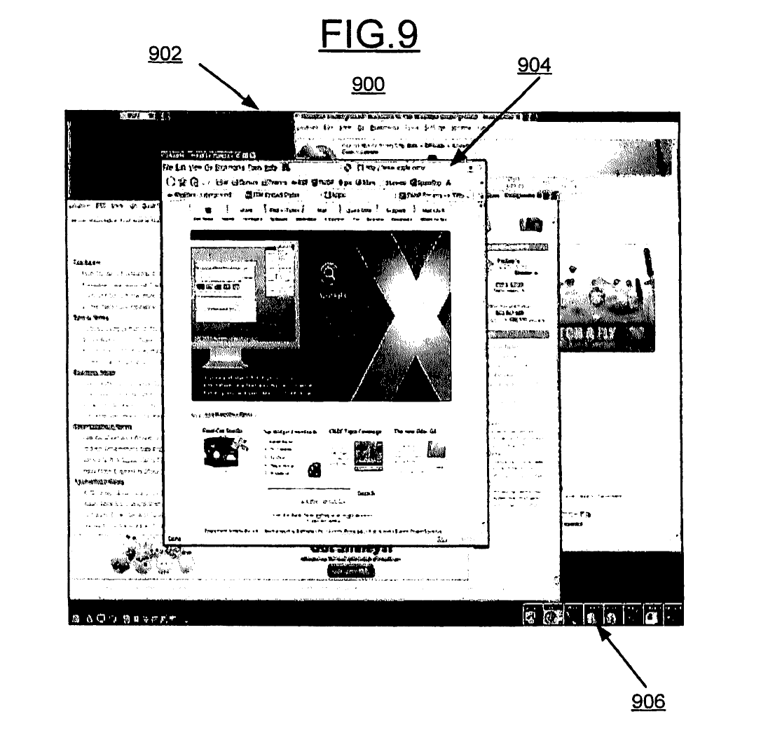

Referring also to FIG. 9, there is shown an exemplary graphical desktop display generally designated by the reference character 900 implementing enhanced window focus in accordance with one preferred embodiment. Graphical desktop display 900 includes a background portion including desktop and background windows generally designated by the reference character 902 having a combination of a selected degree of blurring applied, for example, using a simple Gaussian blur, and color desaturation applied, thus increasing focus on a main window generally designated by the reference character 904. Optionally, as shown, the desktop control toolbars generally designated by the reference character 906 at a lower corner of the screen also remain in focus.

Exemplary operations start as indicated in a decision block 500 with checking whether the desktop is in focus. If the desktop is not in focus, then checking whether distorting by blur is selected as indicated in a decision block 502. When distorting by blur is selected the desktop is blurred to explicitly unfocus the desktop as indicated in a block 504. Next checking whether distorting by desaturation is selected as indicated in a decision block 506. When distorting by desaturation is selected the desktop has its colors desaturated to explicitly unfocus the desktop as indicated in a block 508. Next the desktop is drawn as indicated in a block 510.

Checking for items to update is performed as indicated in a decision block 512. If items to be updated are identified at decision block 512, then checking whether the items to be updated are in focus as indicated in a decision block 514. Then checking whether distorting by blur is selected as indicated in a decision block 516. When distorting by blur is selected the items are blurred to explicitly unfocus the items as indicated in a block 518. Next checking whether distorting by desaturation is selected as indicated in a decision block 520. When distorting by desaturation is selected the items have their colors desaturated to explicitly unfocus the items as indicated in a block 522. Next the items are drawn as indicated in a block 524.

When the items to be updated identified at decision block 512 are identified to be in focus at decision block 514, then the items are drawn at block 524. The unfocus attributes are eliminated based on window activity occurring in a background window to change the window to be in focus, so that the window is drawn without applying any distorting characteristics.

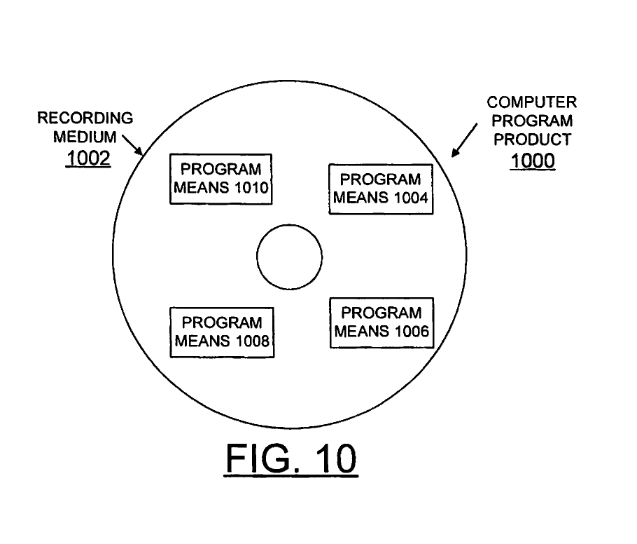

Referring now to FIG. 10, an article of manufacture or a computer program product 1000 of the invention is illustrated. The computer program product 1000 includes a recording medium 1002, such as, a floppy disk, a high capacity read only memory in the form of an optically read compact disk or CD-ROM, a tape, a transmission type media such as a digital or analog communications link, or a similar computer program product. Recording medium 1002 stores program means 1004, 1006, 1008, 1010 on the medium 1002 for carrying out the methods for implementing enhanced window focus in a graphical desktop of the preferred embodiment in the system 100 of FIGS. 1A and 1B.

A sequence of program instructions or a logical assembly of one or more interrelated modules defined by the recorded program means 1004, 1006, 1008, 1010, direct the computer system 100 for implementing enhanced window focus in a graphical desktop of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A computer-implemented method for implementing enhanced window focus in a graphical desktop comprising:
checking whether a desktop is in focus;
responsive to the desktop not being in focus, explicitly distorting the desktop and drawing the desktop;
responsive to identifying an item to be updated, checking whether the item is in focus; and
responsive to the item not being in focus, explicitly distorting the item not being in focus and drawing the item.

2. A computer-implemented method for implementing enhanced window focus as recited in claim 1 includes storing selected background control rules for control of explicitly distorting the desktop and for explicitly distorting items not being in focus.

3. A computer-implemented method for implementing enhanced window focus as recited in claim 1 wherein explicitly distorting the desktop includes adjusting a color saturation of the desktop.

4. A computer-implemented method for implementing enhanced window focus as recited in claim 1 wherein explicitly distorting the desktop includes applying a selected blurring function to the desktop.

5. A computer-implemented method for implementing enhanced window focus as recited in claim 1 wherein explicitly distorting the item not being in focus includes adjusting a color saturation of the item not being in focus.

6. A computer-implemented method for implementing enhanced window focus as recited in claim 1 wherein explicitly distorting the item not being in focus includes applying a selected blurring function to the item not being in focus.

7. A computer-implemented method for implementing enhanced window focus as recited in claim 1 wherein explicitly distorting the item not being in focus includes selectively applying a selected combination of distorting actions to the item not being in focus.

8. A computer-implemented method for implementing enhanced window focus as recited in claim 1 wherein explicitly distorting the desktop includes selectively applying a selected combination of distorting actions to the desktop.

9. A computer-implemented method for implementing enhanced window focus as recited in claim 1 wherein explicitly distorting the desktop and the item not being in focus includes explicitly distorting the desktop and the item not being in focus by a selected one of or a selected combination of desaturating colors of the desktop and item not being in focus, and blurring the desktop and item not being in focus.

10. A computer-implemented method for implementing enhanced window focus as recited in claim 9 wherein blurring the desktop and item not being in focus includes selectively applying a predefined Gaussian blur or a heavy blurring function to the desktop and the item not being in focus.

11. A computer-implemented method for implementing enhanced window focus as recited in claim 9 wherein desaturating colors of the desktop and the item not being in focus includes selectively dimming, inverting, or bleaching the desktop and the item not being in focus.

12. A computer-implemented method for implementing enhanced window focus as recited in claim 1 includes selectively drawing a desktop control toolbar without being distorted.

13. A computer-implemented method for implementing enhanced window focus as recited in claim 1 includes drawing a window without being distorted.

14. A computer program product for implementing enhanced window focus in a graphical desktop, said computer program product including instructions stored on a computer readable storage medium, said instructions when executed by a computer system to cause the computer system to perform the steps of:
checking whether a desktop is in focus;
responsive to the desktop not being in focus, explicitly distorting the desktop and drawing the desktop;
responsive to identifying an item to be updated, checking whether the item is in focus; and
responsive to the item not being in focus, explicitly distorting the item not being in focus and drawing the item.

15. A computer program product as recited in claim 14 further includes selectively drawing a desktop control toolbar without explicitly distorting the desktop control toolbar.

16. A computer program product as recited in claim 14 further includes selectively drawing a window without being distorted.

17. A computer program product as recited in claim 14 wherein explicitly distorting the desktop and the item not being in focus includes explicitly distorting the desktop and the item not being in focus by a selected one of or a selected combination of desaturating colors of the desktop and item not being in focus, and blurring the desktop and item not being in focus.

18. A computer program product as recited in claim 17 wherein blurring the desktop and item not being in focus includes selectively applying a predefined Gaussian blur or a heavy blurring function to the desktop and the item not being in focus; and wherein desaturating colors of the desktop and items not being in focus includes selectively dimming, inverting, or bleaching the desktop and the items not being in focus.

19. A computer program product as recited in claim 14 further includes storing selected background control rules for control of explicitly distorting the desktop and for explicitly distorting the item not being in focus.

20. Apparatus for implementing enhanced window focus in a graphical desktop comprising:
a background control program checking whether a desktop is in focus;
said background control program responsive to the desktop not being in focus, explicitly distorting the desktop and drawing the desktop;
said background control program responsive to identifying an item to be updated, checking whether the item is in focus; and
said background control program responsive to the item not being in focus, explicitly distorting the item not being in focus and drawing the item.
